(19) United States
(12) Patent Application Publication
(10) Pub. No.: US 2023/0342665 A1
(43) Pub. Date: Oct. 26, 2023

(54) METHOD AND APPARATUS FOR SYNCHRONIZING ACTIONS OF LEARNING DEVICES BETWEEN SIMULATED WORLD AND REAL WORLD

(71) Applicant: ELECTRONICS AND TELECOMMUNICATIONS RESEARCH INSTITUTE, Daejeon (KR)

(72) Inventors: HYUNSEOK KIM, Daejeon (KR); Seonghyun KIM, Daejeon (KR); Ingook JANG, Sejong-si (KR)

(21) Appl. No.: 18/091,520

(22) Filed: Dec. 30, 2022

(30) Foreign Application Priority Data
Apr. 21, 2022 (KR) 10-2022-0049329

(51) Int. Cl. G06N 20/00; B25J 9/16

(52) U.S. Cl. CPC G06N 20/00; B25J 9/1605

(57) ABSTRACT

Provided is a method and apparatus for synchronizing actions of robots between a simulated world and a real world. The method may include determining whether the learning device of the simulated world and the learning device of the real world reach the target state after one unit time, when the learning device of the simulated world and the learning device of the real world reach the target state, determining a first delay time, which is a time until the learning device of the simulated world reaches the target state, and a second delay time, which is a time until the learning device of the real world reaches the target state, and performing a correction between a state of the learning device of the simulated world and a state of the learning device of the real world based on the first delay time and the second delay time.

### CROSS-REFERENCE TO RELATED APPLICATION

This application claims the benefit of Korean Patent Application No. 10-2022-0049329 filed on Apr. 21, 2022, in the Korean Intellectual Property Office, the entire disclosure of which is incorporated herein by reference for all purposes.

### BACKGROUND

### 1. Field of the Invention

One or more embodiments relate to a method and apparatus for automatically synchronizing actions of robots between a simulated world and a real world.

### 2. Description of Related Art

Conventional reinforcement learning has been implemented in a simulated world with all variables controlled. However, when learning is performed in conjunction with the real world, stationarity of reinforcement learning may be hardly ensured by a difference between the simulated world and the real world (for example, the time when a motor rotates to move a joint of a robot and the like). Therefore, the difference between the simulated world and the real world may need to be completely controlled to ensure the stationarity.

### SUMMARY

Embodiments provide a method of automatically synchronizing actions of robots between a simulated world and a real world.

Embodiments provide an apparatus for automatically synchronizing actions of robots between a simulated world and a real world.

According to an aspect, there is provided a method of synchronizing actions of learning devices, the method including inputting an action command to a learning device of a simulated world and a learning device of a real world, so that the learning device of the simulated world and the learning device of the real world reach a target state; determining whether the learning device of the simulated world and the learning device of the real world reach the target state after one unit time; when the learning device of the simulated world and the learning device of the real world reach the target state, determining a first delay time, which is a time until the learning device of the simulated world reaches the target state, and a second delay time, which is a time until the learning device of the real world reaches the target state; and performing a correction between a state of the learning device of the simulated world and a state of the learning device of the real world in reinforcement learning that performs learning in conjunction with the learning device of the real world, based on the first delay time and the second delay time.

The performing of the correction may include receiving a next state of the simulated world according to N number of an amount of movement per unit time by as much as a difference between the first delay time and the second delay time; and synchronizing the state of the learning device of the simulated world with the state of the learning device of the real world based on the next state of the simulated world.

The performing of the correction may include adding a dummy time by as much as a difference between the first delay time and the second delay time to a learning device having a short delay time among the learning device of the simulated world and the learning device of the real world.

The determining of whether the learning device of the simulated world and the learning device of the real world reach the target state may include, when the learning device of the simulated world or the learning device of the real world does not reach the target state, adding time to reach the target state; and repeating the adding of the time until the learning device of the simulated world or the learning device of the real world reaches the target state.

The determining of whether the learning device of the simulated world and the learning device of the real world reach the target state may include determining whether the learning devices reach the target state, based on a simulated world state, which is a state after the learning device of the simulated world moves for one unit time, and a real world state, which is a state after the learning device of the real world moves for one unit time.

The learning device of the simulated world may reach the target state by causing a learning device in a monitor of the simulated world to change each joint by as much as an amount of movement per unit time. The amount of movement per unit time may be determined based on a physical state of the simulated world acting on each joint.

The learning device of the real world may reach the target state while reducing an error according to a physical state of the real world acting on each joint.

The learning device of the real world may reduce the error according to the physical state of the real world, based on a proportional control, a differential control, or an integral control.

According to an aspect, there is provided a reinforcement learning apparatus for performing a method of synchronizing actions of learning devices, the reinforcement learning apparatus including a processor. The processor is configured to input an action command to a learning device of a simulated world and a learning device of a real world, so that the learning device of the simulated world and the learning device of the real world reach a target state, determine whether the learning device of the simulated world and the learning device of the real world reach the target state after one unit time, when the learning device of the simulated world and the learning device of the real world reach the target state, determine a first delay time, which is a time until the learning device of the simulated world reaches the target state, and a second delay time, which is a time until the learning device of the real world reaches the target state, and perform a correction between a state of the learning device of the simulated world and a state of the learning device of the real world in reinforcement learning that performs learning in conjunction with the learning device of the real world, based on the first delay time and the second delay time.

The processor may be configured to receive a next state of the simulated world according to N number of an amount of movement per unit time by as much as a difference between the first delay time and the second delay time and synchronize the state of the learning device of the simulated world with the state of the learning device of the real world based on the next state of the simulated world.

The processor may be configured to add a dummy time by as much as a difference between the first delay time and the second delay time to a learning device having a short delay time among the learning device of the simulated world and the learning device of the real world.

The processor may be configured to, when the learning device of the simulated world or the learning device of the real world does not reach the target state, add time to reach the target state and repeat the adding of the time until the learning device of the simulated world or the learning device of the real world reaches the target state.

The processor may be configured to determine whether the learning devices reach the target state, based on a simulated world state, which is a state after the learning device of the simulated world moves for one unit time, and a real world state, which is a state after the learning device of the real world moves for one unit time.

The learning device of the simulated world may reach the target state by causing a learning device in a monitor of the simulated world to change each joint by as much as an amount of movement per unit time. The amount of the movement per unit time may be determined based on a physical state of the simulated world acting on each joint.

The learning device of the real world may reach the target state while reducing an error according to a physical state of the real world acting on each joint.

The learning device of the real world may reduce the error according to the physical state of the real world, based on a proportional control, a differential control, or an integral control.

Additional aspects of embodiments will be set forth in part in the description which follows and, in part, will be apparent from the description, or may be learned by practice of the disclosure.

According to an embodiment, provided is a method of automatically synchronizing actions of robots between a simulated world and a real world.

According to an embodiment, disclosed is an apparatus for automatically synchronizing actions of robots between a simulated world and a real world.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating automatic synchronization of actions of robots between a simulated world and a real world, according to an embodiment;

FIG. 2 is a flowchart illustrating automatic synchronization of actions of robots between a simulated world and a real world, according to an embodiment;

FIG. 3 is an algorithm illustrating automatic synchronization of actions of robots between a simulated world and a real world, according to an embodiment; and

FIG. 4 is a diagram illustrating addition of a dummy time, according to an embodiment.

### DETAILED DESCRIPTION

Hereinafter, embodiments will be described in detail with reference to the accompanying drawings. The scope of the right, however, should not be construed as limited to the embodiments set forth herein. In the drawings, like reference numerals are used for like elements.

Various modifications may be made to the embodiments. Here, the embodiments are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular embodiments only and is not to be limiting of the embodiments. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

Reinforcement learning is a method in which an agent defined in a specific environment recognizes the current state of an environment and learns how to select an action or an order of actions that may maximize a reward provided from the environment, from among selectable actions based on the recognized state. Reinforcement learning may premise the Markov Decision Process, in which a current state is determined based on a result of a past state. Therefore, a learning performance may be improved only when stationarity is guaranteed, in which a state change according to time has a certain statistical characteristic.

Conventional reinforcement learning has been conducted in a simulated world with all variables under control. However, when reinforcement learning performs learning in conjunction with the real world, there may be a difference in a state change between the simulated world and the real world. The difference in the state change may be caused by a difference between the simulated world and the real world (for example, the difference between the time taken in the simulated world and the time taken in the real world when a joint of a robot rotates at a certain angle). In order to guarantee the stationarity of reinforcement learning, the difference may need to be controlled.

Hereinafter, illustrated are a method and apparatus for synchronizing learning devices between the simulated world and the real world to control such a difference. Hereinafter, as an embodiment of a learning device, illustrated is a method of synchronizing actions of robots between the simulated world and the real world

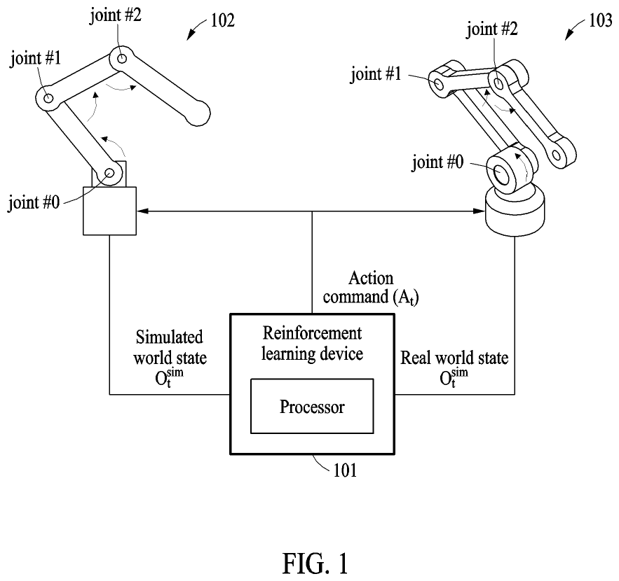

FIG. 1 is a diagram illustrating automatic synchronization of actions of robots between a simulated world and a real world, according to an embodiment.

Referring to FIG. 1, a reinforcement learning apparatus 101, a robot 102 of a simulated world, and a robot 103 of a real world are shown.

The reinforcement learning apparatus 101 may output an action command Aₜ to allow the robot 102 of the simulated world and the robot 103 of the real world to reach a target state. The reinforcement learning apparatus 101 may input the action command Aₜ to the robot 102 of the simulated world and the robot 103 of the real world.

When the action command Aₜ is input to the robot 102 of the simulated world and the robot 103 of the real world, the robot 102 of the simulated world and the robot 103 of the real world may output an action to reach the target state, according to the action command Aₜ.

When the robot 102 of the simulated world moves at once according to the action command Aₜ, the position of the robot 102 of the simulated world on the screen may change instantaneously, which may look unnatural. Therefore, the robot 102 of the simulated world may move little by little per unit time to finally reach the target state.

For example, when an action command to move an arm of a robot from 0 degrees to 90 degrees is received, the robot 102 of the simulated world may move its arm little by little per unit time (e.g., 50 ms) to finally move its arm by 90 degrees.

Therefore, the robot 102 of the simulated world may calculate the total amount that each joint moves, as the amount of movement per unit time (e.g., 50 ms) through a physical simulator of the simulated world, according to the action command Aₜ to move to a target point.

The robot 102 of the simulated world may change each joint of a robot in the simulated world monitor to a position by as much as the amount of movement per unit time to complete the action command Aₜ, which is the final goal.

In this case, the amount that the robot 102 of the simulated world moves per unit time may be calculated by the physical simulator in the simulated world, which estimates a physical state (load, torque, inertia, and the like) of each joint in the simulated world. For example, when the end point of an arm of a robot holding an object is vertically moved by 90 degrees, the amount that the robot 102 of the simulated world moves per unit time may be calculated by estimating a simulated physical quantity (mass, center of gravity, shaking, and the like) of the object, and load and inertia that are applied to each joint. Therefore, the amount of movement per unit time may not be fixed.

The robot 103 of the real world may move an internal actuator of each joint from a starting point to a target point in the form of acceleration-constant velocity-deceleration, according to the action command Aₜ. The robot 103 of the real world may execute proportional-differential-integral control in a direction of reducing an error according to the physical state (load, torque, inertia, and the like) of the real world of each joint, so that the action command Aₜ may be completed.

In this case, the amount that the robot 103 of the real world moves per unit time may change according to the physical state (load, torque, inertia, and the like) of each joint in the real world, so that the amount may not be simply calculated. For example, when the end point of an arm of a robot holding an object is moved vertically by 90 degrees, the amount that the robot 103 of the real world moves per unit time may not accurately perform a modeling of a numerical value on an actual physical amount of the object, and load and inertia, which are applied to each joint, so that the amount that each point moves per unit time may not be easily calculated in advance. Accordingly, the robot 103 of the real world may reduce an error in the amount that the joints actually move, through proportional-differential-integral control, and then adjust an output value of a next actuator. Therefore, the amount of movement per unit time may not be fixed.

Since the robot 103 of the real world operates in a manner of reducing the error with the robot 102 of the simulated world, which estimates the amount of movement by calculation, the amount that the robot 102 of the simulated world moves according to the action command Aₜ may be different from the amount that the robot 103 of the real world moves according to the same action command Aₜ Therefore, there may be a difference between a simulated world state Oₜ^{sim} and a real world state Oₜ^{real}, which include a new position value of each joint, input by the reinforcement learning apparatus 101.

In conclusion, the robot 102 of the simulated world may continue to move by as much as a calculated estimate to reach the target state. The robot 103 of the real world may reach the target state while receiving feedback from a sensor value to reduce an error. Therefore, since how the robot 102 of the simulated world reaches the target state is different from how the robot 103 of the real world reaches the target state, there may be a time difference in reaching the target state between the robot 102 of the simulated world and the robot 103 of the real world.

The reinforcement learning apparatus 101 may learn by determining whether the action command Aₜ is good or bad based on a change in the state value after the action command Aₜ is completed one time and then correcting the action command Aₜ.

In this case, when there is a difference between the simulated world state Oₜ^{sim} and the real world state Oₜ^{real}, the reinforcement learning apparatus 101 may differently determine whether the same action command Aₜ is good or bad to the simulated world and the real world. In this case, the action command Aₜ may not be properly corrected. Therefore, there may be a need for a method of synchronizing actions of learning devices between the simulated world and the real world.

The reinforcement learning apparatus 101 may determine a first delay time, which is a time until the robot 102 of the simulated world reaches a target state. The reinforcement learning apparatus 101 may determine a second delay time, which is a time until the robot 103 of the real world reaches the target state. The reinforcement learning apparatus 101 may perform synchronization on actions of robots between the simulated world and the real world based on the first delay time and the second delay time.

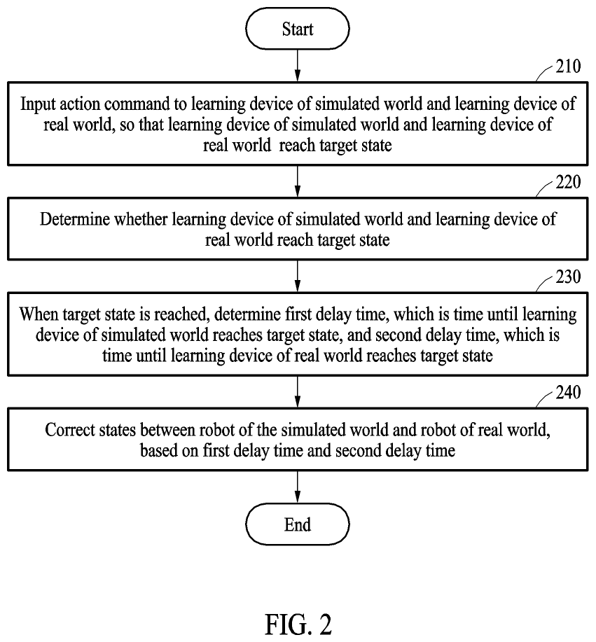

FIG. 2 is a flowchart illustrating automatic synchronization of actions of robots between a simulated world and a real world, according to an embodiment.

In operation 210, a reinforcement learning apparatus 101 may input an action command to a robot 102 of a simulated world and a robot 103 of a real world, so that the robot 102 of the simulated world and the robot 103 of the real world may reach a target state. The robot 102 of the simulated world and the robot 103 of the real world receiving the action command may perform an action to reach the target state according to the action command.

In operation 220, the reinforcement learning apparatus 101 may determine whether the robot 102 of the simulated world and the robot 103 of the real world reach the target state after one unit time. When the robot 102 of the simulated world and the robot 103 of the real world do not reach the target state after the one unit time, the reinforcement learning apparatus 101 may add time to reach the target state. The reinforcement learning apparatus 101 may repeat the addition of time until the robot 102 of the simulated world and the robot 103 of the real world reach the target state.

In operation 230, when the robot 102 of the simulated world and the robot 103 of the real world reach the target state, the reinforcement learning apparatus 101 may determine the first delay time, which is the time until the robot 102 of the simulated world reaches the target state, and the second delay time, which is the time until the robot 103 of the real world reaches the target state.

In operation 240, the reinforcement learning apparatus 101 may correct states between the robot 102 of the simulated world and the robot 103 of the real world, based on the first delay time and the second delay time.

The robot 102 of the simulated world may change from a manner of transferring, to the reinforcement learning apparatus 101, a next state Oₜ^{sim} of the simulated world according to the amount of movement of the robot 102 of the simulated world per time unit for a one-time action command Aₜ of the reinforcement learning, to a manner of transferring, to the reinforcement learning apparatus 101, the next state Oₜ^{sim} of the simulated world according to N number of the amount of movement per unit time by as much as a difference between the first delay time and the second delay time for the one-time action command Aₜ, so that the simulated world state Oₜ^{sim} and the real world state (Val may be synchronized with one another.

The robot 102 of the simulated world may calculate a physical quantity for an operation of the robot 102 of the simulated world, using a physical simulator, and transfer the calculated physical quantity to the next state Oₜ^{sim}. For example, when an arm of a robot moves by about 1 degree per unit time (e.g., 50 ms), a physics simulator may calculate the rotational acceleration of a motor, torque applied to a joint, and the like and may transfer them as the next sate Oₜ^{sim} to the reinforcement learning apparatus 101.

The robot 103 of the real world may measure an actual physical quantity (acceleration of an actual motor, torque applied to a joint, and the like) per unit time that a sensor measures (e.g., 1 ms) and then transfer the actual physical quantity as the next state Oₜ^{real} to the reinforcement learning apparatus 101.

The reinforcement learning apparatus 101 may perform synchronization on states between the simulated world and the real world by adding a dummy time in which the robot having a short delay time takes no action but only consumes time. For example, when the first delay time of the robot 102 of the simulated world is 90 seconds and the second delay time of the robot 103 of the real world is 100 seconds, 10 seconds, which is the difference between the first delay time and the second delay time, may need to be corrected or the robot 102 of the simulated world may perform a next action command before the robot 103 of the real world completes a current action command, which, however, may lead to a difference in movement trajectories of the two robots. Therefore, the reinforcement learning apparatus 101 may add the dummy time to the robot 102 of the simulated world, so that the robot 102 of the simulated world may wait until the robot 103 of the real world completes a current action command.

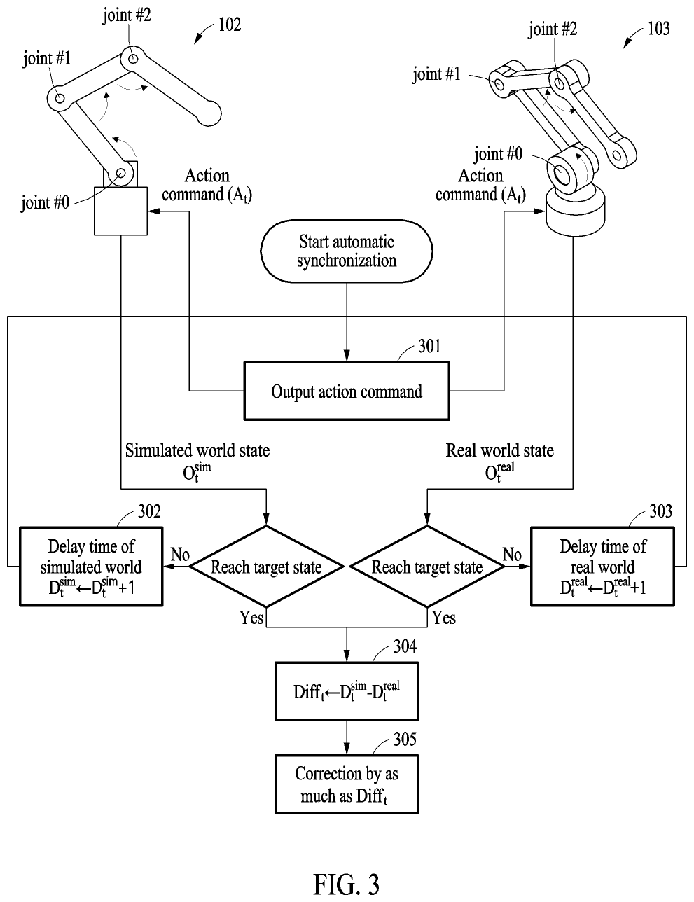

FIG. 3 is an algorithm illustrating automatic synchronization of actions of robots between a simulated world and a real world, according to an embodiment.

In operation 301, a reinforcement learning apparatus 101 may output an action command Aₜ for a robot 102 of a simulated world and a robot 103 of a real world to reach a target state. The action command Aₜ which is output may be input to the robot 102 of the simulated world and the robot 103 of the real world.

The robot 102 of the simulated world may move according to the action command Aₜ for one unit time. The reinforcement learning apparatus 101 may determine a simulated world state Oₜ^{sim}, which is a state after the robot 102 of the simulated world moves for one unit time.

In operation 302, when the simulated world state Oₜ^{sim} is not the target state, the reinforcement learning apparatus 101 may add time to reach the target state. The reinforcement learning apparatus 101 may repeat the addition of time until the target state is reached.

The robot 103 of the real world may move according to the action command Aₜ for one unit time. The reinforcement learning apparatus 101 may determine a simulated world state Oₜ^{real}, which is a state after the robot 103 of the real world moves for one unit time.

In operation 303, when the simulated world state Oₜ^{real} is not the target state, the reinforcement learning apparatus 101 may add time to reach the target state. The reinforcement learning apparatus 101 may repeat the addition of time until the target state is reached.

In operation 304, the reinforcement learning apparatus 101 may determine a difference Diffₜ between a first delay time Dₜ^{sim} and a second delay time Dₜ^{real}. When the robot 102 of the simulated world and the robot 103 of the real world reach the target state, the reinforcement learning apparatus 101 may determine the first delay time Dₜ^{sim}, which is a time until the robot 102 of the simulated world reaches the target state, and the second delay time Dₜ^{real}, which is a time until the robot 103 of the real world reaches the target state.

In operation 305, the reinforcement learning apparatus 101 may determine the difference Diffₜ between the first delay time Dₜ^{sim} and the second delay time Dₜ^{real}. Thereafter, the robot 102 of the simulated world may transfer the next state Oₜ^{sim} of the simulated world according to N number of the amount of movement per unit time by as much as the difference Diffₜ between the first delay time and the second delay time. Then, the reinforcement learning apparatus 101 may perform synchronization on the simulated world state Oₜ^{sim} and the real world state Oₜ^{real}.

Specifically, a reinforcement learning algorithm may correct the next action command Aₜ by determining whether the action command Aₜ is good or bad based on the next state Oₜ^{sim} one time for the action command Aₜ one time.

Therefore, the reinforcement learning apparatus 101 may perform synchronization to solve the abnormal determination of the action command Aₜ according to the difference between the simulated world state Oₜ^{sim} and the real world state Oₜ^{real}. The reinforcement learning apparatus 101 may additionally perform unit time movement on the robot 102 of the simulated world or the robot 103 of the real world, based on the first delay time and the second delay time for the action command Aₜ one time and thus ensure that both of the robots in the simulated world and the real world reach the target state. The reinforcement learning apparatus 101 may add the difference between the first delay time and the second delay time before a certain action per unit time of a robot having a shorter delay time, so that the robots in the simulated world and the real world may reach the target state at the same time.

That is, the reinforcement learning apparatus 101 may perform unit time movement by adding, to the robot having the shorter delay time, a dummy time that consumes only time without performing any action by as much as the difference between the first delay time and the second delay time. As a result, the reinforcement learning apparatus 101 may allow the robot having shorter delay time to perform no action during the dummy time and to thus wait for the other robot to reach the target state. Accordingly, the reinforcement learning apparatus 101 may synchronize the simulated world state (Vim with the real world state Oₜ^{real}.

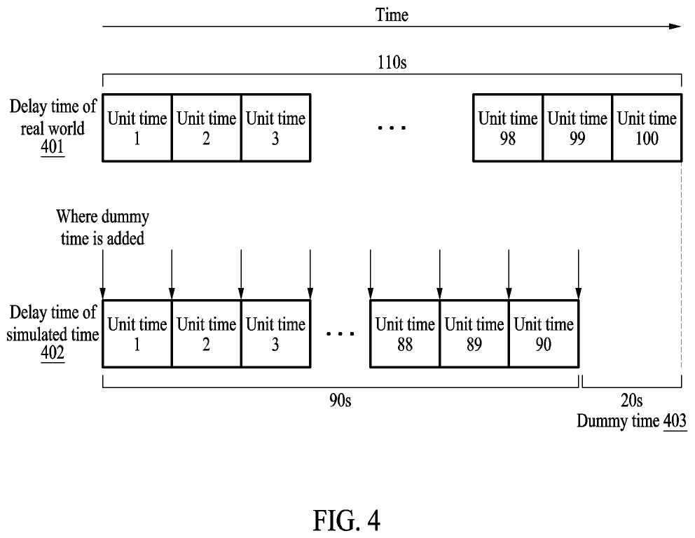

FIG. 4 is a diagram illustrating addition of a dummy time, according to an embodiment.

According to FIG. 4, a delay time 401 of a real world, a delay time 402 of a simulated world, and a dummy time 403 are shown.

In FIG. 4, it is assumed that an action command Aₜ is to move joints of a robot 102 of a simulated world and a robot 103 of a real world from 0 degrees to 90 degrees.

In addition, it is assumed that the amount that the robot 102 of the simulated world moves per unit time is 1 degree and the unit time is 1 s. Therefore, the robot 102 of the simulated world may move a joint by 1 degree for 1 s. It is assumed that the amount that the robot 103 of the real world moves per unit time is 0.9 degrees and the unit time is 1.1 s. Therefore, the robot 103 of the real world may move a joint by 0.9 degrees for 1.1 s.

In this case, since the robot 103 of the real world consumes 110 seconds to move 90 degrees, the second delay time 401 of the real world may be 110 s. The first delay time, which is the delay time 402 of the simulated world, may be 90 s because it takes 90 seconds to move 90 degrees.

In FIG. 4, the horizontal axis denotes time. Therefore, in the delay time 401 of the real world, unit time 1 to unit time 100 may each have a time length of 1.1 s. In the delay time 402 of the simulated world, unit time 1 to unit time 90 may each have a time length of 1 s.

Since the dummy time 403 is the difference between the first delay time and the second delay time, the dummy time may be 20 s, which is the difference between 110 s and 90 s.

According to an embodiment, the reinforcement learning apparatus 101 may add, to a robot having a shorter delay time, a dummy time consuming time without performing any action by as much as the difference between the first delay time and the second delay time, thus performing a movement of unit time. Accordingly, in this case, the reinforcement learning apparatus 101 may insert the dummy time 403 into the robot 102 of the simulated world having a shorter delay time.

According to another embodiment, the reinforcement learning apparatus 101 may insert the dummy time 403 before or after each unit time of the robot 102 of the simulated world. That is, the reinforcement learning apparatus 101 may add the dummy time 403 before or after unit time 1 to unit time 90, which are the unit time of the robot 102 of the simulated world. In this case, when the dummy time 403 is added before a specific unit time, the corresponding unit time may be moved backward by as much as the added dummy time.

For example, when the reinforcement learning apparatus 101 inserts the dummy time 403 after the unit time 90, the robot 102 of the simulated world may wait for 20 s without taking any action after reaching the target state. When the reinforcement learning apparatus 101 inserts the dummy time 403 after unit time 3, the robot 102 of the simulated world may move a joint by 3 degrees for 3 seconds, wait for 20 s without taking any action, and start to move again from unit time 4. Therefore, unit time 4 may move by as much as 20 s.

According to another embodiment, the reinforcement learning apparatus 101 may divide the dummy time 403 into a certain length of time and insert it before or after a plurality of unit times. For example, the reinforcement learning apparatus 101 may divide 20 s into 10 s, 6 s, and 4 s and add 10 s after unit time 2, 6 s after unit time 88, and 4 s after unit time 90.

As a result, the robot having a shorter delay time may wait for the dummy time, so that when a next action command is input, the robot of the real world and the robot of the simulated world may simultaneously execute the next action command. That is, state synchronization may be performed between the robot of the real world and the robot of the simulated world.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Embodiments of information carriers suitable for embodying computer program instructions and data include semiconductive wire memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is to required for all the embodiments, and it should be understood that the aforementioned program components and apparatuses may be integrated into a single software product or packaged into multiple software products.

The embodiments disclosed in the present specification and the drawings are intended merely to present specific embodiments in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. A method of synchronizing actions of learning devices, the method comprising:
inputting an action command to a learning device of a simulated world and a learning device of a real world, so that the learning device of the simulated world and the learning device of the real world reach a target state;
determining whether the learning device of the simulated world and the learning device of the real world reach the target state after one unit time;
when the learning device of the simulated world and the learning device of the real world reach the target state, determining a first delay time, which is a time until the learning device of the simulated world reaches the target state, and a second delay time, which is a time until the learning device of the real world reaches the target state; and
performing a correction between a state of the learning device of the simulated world and a state of the learning device of the real world in reinforcement learning that performs learning in conjunction with the learning device of the real world, based on the first delay time and the second delay time.

2. The method of claim 1, wherein the performing of the correction comprises:
receiving a next state of the simulated world according to N number of an amount of movement per unit time by as much as a difference between the first delay time and the second delay time; and
synchronizing the state of the learning device of the simulated world with the state of the learning device of the real world based on the next state of the simulated world.

3. The method of claim 1, wherein the performing of the correction comprises adding a dummy time by as much as a difference between the first delay time and the second delay time to a learning device having a short delay time among the learning device of the simulated world and the learning device of the real world.

4. The method of claim 1, wherein the determining of whether the learning device of the simulated world and the learning device of the real world reach the target state comprises:
when the learning device of the simulated world or the learning device of the real world does not reach the target state, adding time to reach the target state; and
repeating the adding of the time until the learning device of the simulated world or the learning device of the real world reaches the target state.

5. The method of claim 1, wherein the determining of whether the learning device of the simulated world and the learning device of the real world reach the target state comprises determining whether the learning devices reach the target state, based on a simulated world state, which is a state after the learning device of the simulated world moves for one unit time, and a real world state, which is a state after the learning device of the real world moves for one unit time.

6. The method of claim 1, wherein the learning device of the simulated world reaches the target state by causing a learning device in a monitor of the simulated world to change each joint by as much as an amount of movement per unit time,
wherein the amount of movement per unit time is determined based on a physical state of the simulated world acting on each joint.

7. The method of claim 1, wherein the learning device of the real world reaches the target state while reducing an error according to a physical state of the real world acting on each joint.

8. The method of claim 7, wherein the learning device of the real world reduces the error according to the physical state of the real world, based on a proportional control, a differential control, or an integral control.

9. A reinforcement learning apparatus for performing a method of synchronizing actions of learning devices, the reinforcement learning apparatus comprising a processor,
wherein the processor is configured to:
input an action command to a learning device of a simulated world and a learning device of a real world, so that the learning device of the simulated world and the learning device of the real world reach a target state;
determine whether the learning device of the simulated world and the learning device of the real world reach the target state after one unit time;
when the learning device of the simulated world and the learning device of the real world reach the target state, determine a first delay time, which is a time until the learning device of the simulated world reaches the target state, and a second delay time, which is a time until the learning device of the real world reaches the target state; and
perform a correction between a state of the learning device of the simulated world and a state of the learning device of the real world in reinforcement learning that performs learning in conjunction with the learning device of the real world, based on the first delay time and the second delay time.

10. The reinforcement learning apparatus of claim 9, wherein the processor is configured to:
receive a next state of the simulated world according to N number of an amount of movement per unit time by as much as a difference between the first delay time and the second delay time; and
synchronize the state of the learning device of the simulated world with the state of the learning device of the real world based on the next state of the simulated world.

11. The reinforcement learning apparatus of claim 9, wherein the processor is configured to add a dummy time by as much as a difference between the first delay time and the second delay time to a learning device having a short delay time among the learning device of the simulated world and the learning device of the real world.

12. The reinforcement learning apparatus of claim 9, wherein the processor is configured to:
when the learning device of the simulated world or the learning device of the real world does not reach the target state, add time to reach the target state; and
repeat the adding of the time until the learning device of the simulated world or the learning device of the real world reaches the target state.

13. The reinforcement learning apparatus of claim 9, wherein the processor is configured to determine whether the learning devices reach the target state, based on a simulated world state, which is a state after the learning device of the simulated world moves for one unit time, and a real world state, which is a state after the learning device of the real world moves for one unit time.

14. The reinforcement learning apparatus of claim 9, wherein the learning device of the simulated world reaches the target state by causing a learning device in a monitor of the simulated world to change each joint by as much as an amount of movement per unit time,
wherein the amount of movement per unit time is determined based on a physical state of the simulated world acting on each joint.

15. The reinforcement learning apparatus of claim 9, wherein the learning device of the real world reaches the target state while reducing an error according to a physical state of the real world acting on each joint.

16. The reinforcement learning apparatus of claim 15, wherein the learning device of the real world reduces the error according to the physical state of the real world, based on a proportional control, a differential control, or an integral control.
